(19) United States
(12) Patent Application Publication
(10) Pub. No.: US 2025/0164693 A1
(43) Pub. Date: May 22, 2025

(54) OPTICAL WAVEGUIDE DEVICE

(71) Applicant: SHINKO ELECTRIC INDUSTRIES CO., LTD., Nagano-shi (JP)

(72) Inventor: Kazunao Yamamoto, Nagano (JP)

(21) Appl. No.: 18/949,099

(22) Filed: Nov. 15, 2024

(30) Foreign Application Priority Data
Nov. 20, 2023 (JP) 2023-196409

(51) Int. Cl. G02B 6/26

(52) U.S. Cl. CPC G02B 6/26

(57) ABSTRACT

An optical waveguide device has a first optical waveguide, a second optical waveguide, and an adhesive layer. The first optical waveguide has: a first cladding; and a first core having a distal end portion exposed from the first cladding. The second optical waveguide has: a second cladding; and a second core having a distal end portion exposed from the second cladding. The adhesive layer adheres the first optical waveguide and the second optical waveguide in a state where the distal end portions of the first core and of the second core have been arranged to partially overlap each other. The adhesive layer covers lateral surfaces of the distal end portions of the first core and of the second core and has a refractive index closer to refractive indexes of the first cladding and the second cladding than to refractive indexes of the first core and the second core.

### CROSS-REFERENCE TO RELATED APPLICATION

This application is based upon and claims the benefit of priority of the prior Japanese Patent Application No. 2023-196409, filed on Nov. 20, 2023, the entire contents of which are incorporated herein by reference.

### FIELD

The embodiment discussed herein is related to optical waveguide devices.

### BACKGROUND

An optical waveguide device to optically couple two optical waveguides to each other by adhesion has been known conventionally. Each of the two optical waveguides includes cladding and a core having a portion with a surface exposed from the cladding.

In optical coupling between the two optical waveguides, the exposed surface of the core in one of the optical waveguides and the exposed surface of the core in the other one of the optical waveguides are superposed on each other in a planar view and the exposed surface of the core in the one of the optical waveguides and the exposed surface of the core in the other one of the optical waveguides are thereafter adhered to each other via an adhesive layer.

Patent Literature 1: Japanese Laid-open Patent Publication No 2015-191110

However, in the case where the adhesive layer is interposed between the exposed surface of the core in the one of the optical waveguides and the exposed surface of the core in the other one of the optical waveguides, there is a problem that movement of light between the cores is obstructed and optical coupling loss between the two optical waveguides adhered to each other is increased. That is, the refractive index of the adhesive layer interposed between the cores of the two optical waveguides is adjusted to be a refractive index comparatively close to the refractive index of the cores of the two optical waveguides and thus light moving from one of the cores to the other one of the cores leaks out from the optical waveguides via the adhesive layer and the optical coupling loss is thereby increased.

### SUMMARY

According to an aspect of an embodiment, an optical waveguide device includes a first optical waveguide having: a first cladding; and a first core having a distal end portion exposed from the first cladding; a second optical waveguide having: a second cladding made of a same material as the first cladding; and a second core made of a same material as the first core, the second core having a distal end portion exposed from the second cladding; and an adhesive layer that adheres the first optical waveguide and the second optical waveguide to each other in a state where the distal end portion of the first core and the distal end portion of the second core have been arranged to partially overlap each other, wherein the adhesive layer is filled in between the first cladding and the second cladding to cover lateral surfaces of the distal end portion of the first core and of the distal end portion of the second core and has a refractive index closer to refractive indexes of the first cladding and the second cladding than to refractive indexes of the first core and the second core.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a plan view illustrating a configuration of an optical waveguide device according to an embodiment;

FIG. 2 is a diagram schematically illustrating a cross section on a line II-II in FIG. 1;

FIG. 3 is a diagram schematically illustrating a cross section on a line III-III in FIG. 2;

FIG. 4 is a diagram schematically illustrating a cross section on a line IV-IV in FIG. 2;

FIG. 5 is a diagram schematically illustrating a cross section on a line V-V in FIG. 2;

FIG. 6 is a flowchart illustrating a method of manufacturing a first optical waveguide according to the embodiment;

FIG. 7 is a flowchart illustrating a method of manufacturing a second optical waveguide according to the embodiment; and

FIG. 8 is a flowchart illustrating a method of manufacturing the optical waveguide device according to the embodiment.

### DESCRIPTION OF EMBODIMENT

An embodiment of an optical waveguide device disclosed by the present application will hereinafter be described in detail, on the basis of the drawings. Techniques disclosed herein are not to be limited by this embodiment.

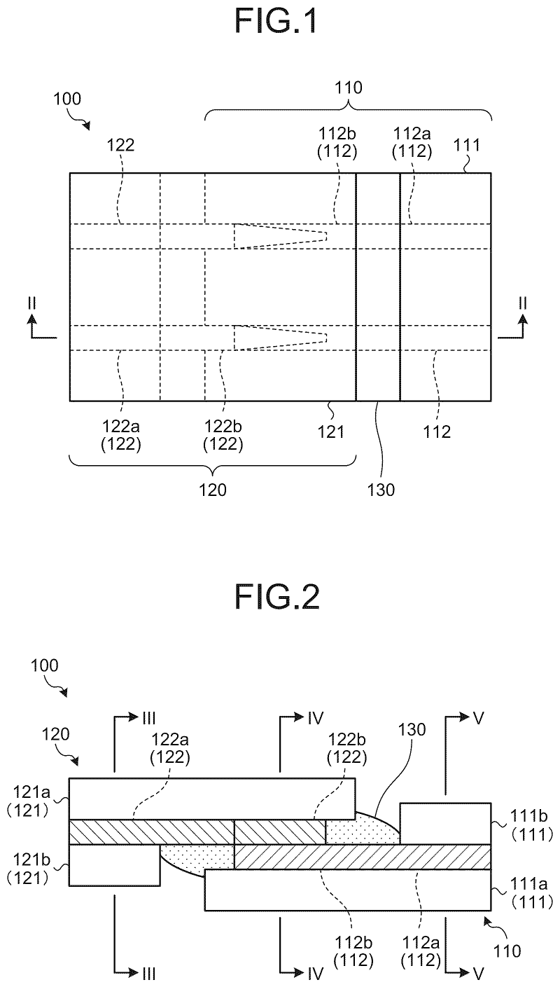

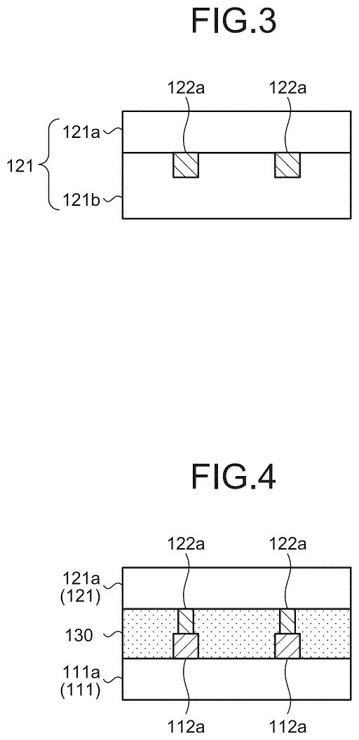

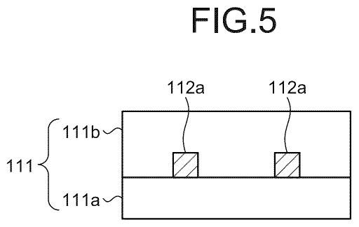

FIG. 1 is a plan view illustrating a configuration of an optical waveguide device 100 according to the embodiment. FIG. 2 is a diagram schematically illustrating a cross section on a line II-II in FIG. 1. FIG. 3 is a diagram schematically illustrating a cross section on a line III-III in FIG. 2. FIG. 4 is a diagram schematically illustrating a cross section on a line IV-IV in FIG. 2. FIG. 5 is a diagram schematically illustrating a cross section on a line V-V in FIG. 2.

As illustrated in FIG. 1 and FIG. 2, the optical waveguide device 100 includes a first optical waveguide 110 and a second optical waveguide 120 that have been adhered to each other by an adhesive layer 130.

The first optical waveguide 110 has first cladding 111 and a first core 112.

The first cladding 111 is made of, for example, a transparent material, such as a thermosetting or light-curable epoxy resin or silicon dioxide (SiO₂), and is configured to surround one of end portions (hereinafter, referred to as a “proximal end portion 112a”) of the first core 112. The first cladding 111 includes a material having a refractive index different from that of the first core 112 and totally reflects light in the first core 112 at an interface between the first cladding 111 and the first core 112.

As illustrated in FIG. 2 and FIG. 5, the first cladding 111 includes first lower cladding 111a and first upper cladding 111b and the first lower cladding 111a and the first upper cladding 111b surround the proximal end portion 112a of the first core 112 formed on the first lower cladding 111a. The first upper cladding 111b is formed on the first lower cladding 111a such that the first upper cladding 111b covers the proximal end portion 112a of the first core 112, the proximal end portion 112a excluding the other one of the end portions (hereinafter, referred to as a “distal end portion 112b”) of the first core 112. In an area of the first lower cladding 111a, the first cladding 111 exposes the distal end portion 112b of the first core 112, the area not overlapping the first upper cladding 111b in a planar view.

The first core 112 is a path where light is transmitted through. The first core 112 is made of, for example, a transparent material, such as a thermosetting or light-curable epoxy resin or silicon (Si), and has, as illustrated in FIG. 1 and FIG. 2, the proximal end portion 112a and the distal end portion 112b. The proximal end portion 112a of the first core 112 is a portion surrounded by the first cladding 111 (that is, the first lower cladding 111a and the first upper cladding 111b). An end face of the proximal end portion 112a is exposed at a lateral surface of the first optical waveguide 110 and serves as a connection surface where an optical transmission component, such as an optical fiber, is connected. The distal end portion 112b of the first core 112 is a portion exposed from the first cladding 111, in the area of the first lower cladding 111a, the area not overlapping the first upper cladding 111b in a planar view. The distal end portion 112b of the first core 112 is arranged to partially overlap a distal end portion 122b of a second core 122 described later. The first core 112 transmits light that leaks out to the distal end portion 112b from the distal end portion 122b of the second core 122 in a longitudinal direction of the first core 112 and guides the light to the end face of the proximal end portion 112a.

The second optical waveguide 120 has second cladding 121 and the second core 122.

The second cladding 121 is made of the same material as the first cladding 111 and is configured to surround one of end portions of the second core 122 (hereinafter, referred to as a “proximal end portion 122a”). The second cladding 121 is made of a material having a refractive index different from that of the second core 122 and totally reflects light in the second core 122 at an interface between the second cladding 121 and the second core 122.

As illustrated in FIG. 2 and FIG. 3, the second cladding 121 includes second lower cladding 121a and second upper cladding 121b and the second lower cladding 121a and the second upper cladding 121b surround the proximal end portion 122a of the second core 122 formed on the second lower cladding 121a. The second upper cladding 121b is formed on the second lower cladding 121a such that the second upper cladding 121b covers the proximal end portion 122a of the second core 122, the proximal end portion 122a excluding the other one of the end portions (hereinafter, referred to as a “distal end portion 122b”) of the second core 122. The second cladding 121 exposes the distal end portion 122b of the second core 122, in an area of the second lower cladding 121a, the area not overlapping the second upper cladding 121b in a planar view.

The second core 122 is a path where light is transmitted through. The second core 122 is made of the same material as the first core 112 and has, as illustrated in FIG. 1 and FIG. 2, the proximal end portion 122a and the distal end portion 122b. The proximal end portion 122a of the second core 122 is a portion surrounded by the second cladding 121 (that is, the second lower cladding 121a and the second upper cladding 121b). An end face of the proximal end portion 122a is exposed at a lateral surface of the second optical waveguide 120 and serves as a connection surface where an optical transmission component, such as an optical fiber, is connected. The distal end portion 122b of the second core 122 is a portion exposed from the second cladding 121, in the area of the second lower cladding 121a, the area not overlapping the second upper cladding 121b in a planar view. The distal end portion 122b of the second core 122 is arranged to partially overlap the distal end portion 112b of the first core 112. The distal end portion 122b of the second core 122 has a tapered shape that decreases in core width toward a distal end thereof. The second core 122 transmits light input from the end face of the proximal end portion 122a in a longitudinal direction of the second core 122 and causes the light to leak out to the distal end portion 112b of the first core 112 from the distal end portion 122b.

The adhesive layer 130 is made of, for example, a material, such as a thermosetting or light-curable epoxy resin, and adheres the first optical waveguide 110 and the second optical waveguide 120 to each other in a state where the distal end portion 112b of the first core 112 and the distal end portion 122b of the second core 122 have been arranged to partially overlap each other. Specifically, as illustrated in FIG. 2 and FIG. 4, the adhesive layer 130 adheres the first cladding 111 in the first optical waveguide 110 and the second cladding 121 in the second optical waveguide 120 to each other.

In this embodiment, the adhesive layer 130 covers lateral surfaces of the distal end portion 112b of the first core 112 and of the distal end portion 122b of the second core 122 by being filled in between the first cladding 111 and the second cladding 121. The adhesive layer 130 has a refractive index closer to the refractive index of the first cladding 111 and second cladding 121 than to the refractive index of the first core 112 and second core 122. That is, similarly to the first cladding 111 and the second cladding 121, the adhesive layer 130 is formed of a material having a refractive index enabling total reflection of light in the first core 112 and light in the second core 122 at interfaces between the adhesive layer 130 and the first and second cores 112 and 122. Therefore, leakage of light moving from the second core 122 to the first core 112 to outside of the optical waveguides via the adhesive layer 130 is able to be minimized and as a result, optical coupling loss between the first optical waveguide 110 and the second optical waveguide 120 adhered to each other is able to be reduced.

Furthermore, in this embodiment, as illustrated in FIG. 2, the adhesive layer 130 covers end faces of the distal end portion 112b of the first core 112 and of the distal end portion 122b of the second core 122. Therefore, leakage of light from the end faces of the distal end portion 112b of the first core 112 and of the distal end portion 112b of the second core 122 is able to be minimized, and as a result, optical coupling loss between the first optical waveguide 110 and the second optical waveguide 120 adhered to each other is able to be reduced.

A method of manufacturing the optical waveguide device 100 configured as described above will be described next. The method of manufacturing the optical waveguide device 100 having the first optical waveguide 110 and the second optical waveguide 120 will hereinafter be described after description of a method of manufacturing the first optical waveguide 110 and a method of manufacturing the second optical waveguide 120.

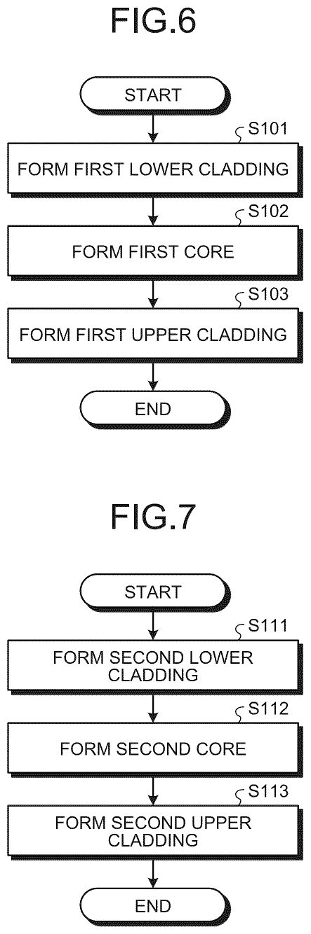

FIG. 6 is a flowchart illustrating the method of manufacturing the first optical waveguide 110 according to the embodiment.

First, the first lower cladding 111a is formed on a base not illustrated in the drawings (Step S101). Specifically, an epoxy resin arranged on the base and in a partially cured state, for example, is cured by heating or irradiation with light, such as ultraviolet light, and thereby forms the first lower cladding 111a.

The first core 112 is then formed on the first lower cladding 111a (Step S102). Specifically, an epoxy resin arranged and shaped on the first lower cladding 111a and in a partially cured state, for example, is cured by heating or irradiation with light, such as ultraviolet light, and thereby forms the first core 112. For example, the first core 112 formed has a rectangular parallelepiped shape extending from one end of the first lower cladding 111a to a position not reaching the other end of the first lower cladding 111a.

The first upper cladding 111b covering the proximal end portion 112a of the first core 112 is then formed on the first lower cladding 111a (Step S103). Specifically, an epoxy resin arranged on the first lower cladding 111a and in a partially cured state, for example, so as to cover the proximal end portion 112a of the first core 112 is cured by heating or irradiation with light, such as ultraviolet light, and thereby forms the first upper cladding 111b. In the area of the first lower cladding 111a, the distal end portion 112b of the first core 112 is exposed from the first cladding 111, the area not overlapping the first upper cladding 111b in a planar view. The first optical waveguide 110, in which the distal end portion 112b of the first core 112 is exposed from the first cladding 111, is thereby completed. The base may be peeled from the first lower cladding 111a as needed.

Next, FIG. 7 is a flowchart illustrating the method of manufacturing the second optical waveguide 120 according to the embodiment.

First, the second lower cladding 121a is formed on a base not illustrated in the drawings (Step S111). Specifically, an epoxy resin arranged on the base and in a partially cured state, for example, is cured by heating or irradiation with light, such as ultraviolet light, and thereby forms the second lower cladding 121a.

The second core 122 is then formed on the second lower cladding 121a (Step S112). Specifically, an epoxy resin arranged and shaped on the second lower cladding 121a and in a partially cured state, for example, is cured by heating or irradiation with light, such as ultraviolet light, and thereby forms the second core 122. For example, the second core 122 formed extends from one end of the second lower cladding 121a to a position not reaching the other end of the second lower cladding 121a, and has the proximal end portion 112a having a rectangular parallelepiped shape and the distal end portion 122b having a tapered shape.

The second upper cladding 121b covering the proximal end portion 122a of the second core 122 is then formed on the second lower cladding 121a (Step S113). Specifically, an epoxy resin arranged on the second lower cladding 121a and in a partially cured state, for example, so as to cover the proximal end portion 122a of the second core 122 is cured by heating or irradiation with light, such as ultraviolet light, and thereby forms the second upper cladding 121b. In the area of the second lower cladding 121a, the distal end portion 122b of the second core 122 is exposed from the second cladding 121, the area not overlapping the second upper cladding 121b in a planar view. The second optical waveguide 120, in which the distal end portion 122b of the second core 122 is exposed from the second cladding 121, is thereby completed. The base may be peeled from the second lower cladding 121a as needed.

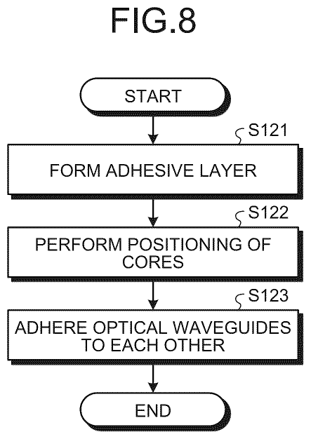

Next, FIG. 8 is a flowchart illustrating the method of manufacturing the optical waveguide device 100 according to the embodiment. The optical waveguide device 100 is manufactured using the first optical waveguide 110 and the second optical waveguide 120 described above.

First, the adhesive layer 130 is formed in the second optical waveguide 120 (Step S121). Specifically, the adhesive layer 130 in a partially cured state is formed by application of an epoxy resin in a partially cured state to an area positioned around the distal end portion 122b of the second core 122, the area being in the area of the second lower cladding 121a not overlapping the second upper cladding 121b in a planar view.

Subsequently, positioning of the first core 112 of the first optical waveguide 110 and the second core 122 of the second optical waveguide 120 is performed (Step S122). Specifically, the positioning is done so that the distal end portion 112b of the first core 112 and the distal end portion 112b of the second core 122 are arranged to partially overlap each other.

Subsequently, the first optical waveguide 110 and the second optical waveguide 120 are adhered to each other by the adhesive layer 130 in the state where the distal end portion 112b of the first core 112 and the distal end portion 122b of the second core 122 have been arranged to partially overlap each other (Step S123). Specifically, first, the first cladding 111 in the first optical waveguide 110 and the second cladding 121 in the second optical waveguide 120 are adhered to each other by the adhesive layer 130. In this adhesion, the adhesive layer 130 covers the lateral surfaces and the end faces of the distal end portion 112b of the first core 112 and of the distal end portion 122b of the second core 122 by being filled in between the first cladding 111 and the second cladding 121. Thereafter, the adhesive layer 130 is thermally cured. The optical waveguide device 100 thereby obtained has the first optical waveguide 110 and the second optical waveguide 120 adhered to each other by the adhesive layer 130 having a refractive index closer to the refractive index of the first cladding 111 and the second cladding 121 than to the refractive index of the first core 112 and second core 122.

The case where the distal end portion 122b of the second core 122 has a tapered shape that decreases in core width toward the distal end has been described above with respect to the embodiment, but the distal end portion 112b of the first core 112 may have a tapered shape.

As described above, an optical waveguide device according to the embodiment (for example, the optical waveguide device 100) has a first optical waveguide (for example, the first optical waveguide 110), a second optical waveguide (for example, the second optical waveguide 120), and an adhesive layer (for example, the adhesive layer 130). The first optical waveguide has first cladding (for example, the first cladding 111) and a first core (for example, the first core 112) having a distal end portion (for example, the distal end portion 112b) exposed from the first cladding. The second optical waveguide has second cladding (for example, the second cladding 121) made of a material that is the same as that of the first cladding, and a second core (for example, the second core 122) made of a material that is the same as that of the first core and having a distal end portion (for example, the distal end portion 122b) exposed from the second cladding. The adhesive layer adheres the first optical waveguide and the second optical waveguide to each other in a state where the distal end portion of the first core and the distal end portion of the second core have been arranged to partially overlap each other. The adhesive layer covers lateral surfaces of the distal end portion of the first core and of the distal end portion of the second core by being filled in between the first cladding and the second cladding, and has a refractive index closer to a refractive index of the first cladding and second cladding than to a refractive index of the first core and second core. Optical coupling loss between the two optical waveguides adhered to each other is thereby able to be reduced.

The adhesive layer may cover end faces of the distal end portion of the first core and of the distal end portion of the second core. The optical coupling loss between the two optical waveguides adhered to each other is thereby able to be reduced even further.

The distal end portion of the first core or the distal end portion of the second core may have a tapered shape that decreases in core width toward a distal end thereof. The optical coupling loss between the two optical waveguides adhered to each other is thereby able to be reduced even further.

An optical waveguide device disclosed by the present application has, in one aspect, an effect of enabling reduction in optical coupling loss between two optical waveguides that are adhered to each other.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical waveguide device, comprising:
a first optical waveguide having: a first cladding;
and a first core having a distal end portion exposed from the first cladding;
a second optical waveguide having: a second cladding made of a same material as the first cladding; and a second core made of a same material as the first core, the second core having a distal end portion exposed from the second cladding; and
an adhesive layer that adheres the first optical waveguide and the second optical waveguide to each other in a state where the distal end portion of the first core and the distal end portion of the second core have been arranged to partially overlap each other, wherein
the adhesive layer is filled in between the first cladding and the second cladding to cover lateral surfaces of the distal end portion of the first core and of the distal end portion of the second core and has a refractive index closer to refractive indexes of the first cladding and the second cladding than to refractive indexes of the first core and the second core.

2. The optical waveguide device according to claim 1, wherein the adhesive layer covers end faces of the distal end portion of the first core and of the distal end portion of the second core.

3. The optical waveguide device according to claim 1, wherein the distal end portion of the first core or the distal end portion of the second core has a tapered shape that decreases in core width toward a distal end thereof.
